(19) United States
(12) Patent Application Publication
(10) Pub. No.: US 2011/0076905 A1
(43) Pub. Date: Mar. 31, 2011

(54) PRESSURE-SENSITIVE ADHESIVE COMPOSED OF POLYPROPYLENE RESIN

(75) Inventors: Bernhard Müssig, Seevetal (DE); Dennis Seitzer, Hamburg (DE)

(73) Assignee: TESA SE, Hamburg (DE)

(21) Appl. No.: 12/993,449

(22) PCT Filed: May 29, 2009
(86) PCT No.: PCT/EP09/56632

§ 371 Date: Dec. 14, 2010

(30) Foreign Application Priority Data
Jun. 4, 2008 (DE) 10 2008 026 672.8

(51) Int. Cl. C09J 7/04; C09J 7/02; C09J 123/12; C09J 153/00; C09J 151/00

(52) U.S. Cl. 442/151; 428/341; 428/355 EN; 428/354; 428/317.3; 525/55; 525/95; 525/70; 524/274; 524/306; 524/502; 524/528; 524/384

(57) ABSTRACT

Pressure sensitive adhesive comprised of a polypropylene resin of low density and high melting point and at least one tackifying resin

The invention relates to a pressure-sensitive adhesive comprising a polypropylene resin of low density with high melting point, and comprising at least one tackifier resin, and also to use in an adhesive tape. The adhesive tape is suitable, for example, for bonding to low-energy surfaces.

Random copolymers with a high comonomer fraction (also called plastomers) have a low crystallinity and low melting point of approximately 40° C. to 60° C. or are amorphous. They are used as flexibilizers or impact toughener additives for hard polyolefins. They comprise mostly ethylene as principal monomer, and, as comonomer, propylene, butene, octene or vinyl acetate. They are used only to a limited extent for hotmelt adhesives, since the low melting point means that they are not heat-resistant. For applications (for example, carton bonding, diaper manufacture, hotmelt guns), therefore, adhesives comprising EVA, tackifier (tackifier resin), and wax are typically employed.

Soft random copolymers of this kind are proposed as a coextrusion layer for slightly tacky and readily redetachable surface protection films. These films at room temperature have no significant bond strength (i.e, below 0.1 N/cm), but above the melting point can be sealed to panels of polycarbonate, acrylic glass or ABS, as protection from scratching, and later removed again at room temperature. If the coextrusion layer, however, comprises a polar comonomer such as vinyl acetate, the protective film is difficult to remove later on. Surface protection films made from a soft random copolymer do not store well, since at a slightly elevated storage temperature, the rolls suffer blocking, which means that they cannot be unrolled again, and they also have no heat resistance for the user. It is therefore usual to employ random copolymers having a melting point of above 60° C., despite the fact that a high sealing temperature is then necessary.

Alternatively, films with a pressure-sensitive adhesive coating of polyacrylate or synthetic rubber are also used.

These soft random copolymers are also proposed for surface protection films which are tacky at room temperature (23° C.). Through the addition of a small amount of plasticizer or tackifier (resin), the crystallinity is reduced to an extent such that good tack is achieved to plastics panels or polished steel panels even at room temperature. Such adhesives, however, have an even lower heat resistance than coextruded layers with a soft random copolymer. Moreover, following removal from such panels, they leave behind a thin covering, which the skilled person refers to as ghosting. For these reasons they have not become established for such applications. For pressure-sensitively adhesive surface protection films, therefore, it is usual to use films having a coating of polyacrylate or synthetic rubber adhesive.

Soft polymers with no crystallinity or with negligible crystallinity, such as polyisobutylene or EPDM rubbers, are also not pressure-sensitively adhesive, which means that they have no significant bond strength. Although very smooth layers of such soft polyolefins may adhere slightly to very smooth substrates such as glass or polycarbonate panels, their behavior is the same as that of smooth layers of natural rubber, butyl rubber or highly plasticized PVC. Such materials are able to hold their own weight, and so do not drop off automatically, but under a peel load they have virtually no resistance, since their glass transition temperature, compared with a pressure-sensitive adhesive, is much too low. Furthermore, such materials tend toward coalescence on storage, since crystallinity is inadequate, and are therefore supplied in the form of blocks (bales), which cannot be processed on an extruder. Furthermore, on account of their very low or absent crystallite melting point, they have no heat resistance.

Adhesive tapes comprise or consist of at least one layer of (pressure-sensitive) adhesive, based typically on natural rubber, synthetic rubber (for example, polyisobutylene, styrene block copolymer, EVA, SBR) in combination with a tackifier resin or polyacrylate, and, very rarely, of very expensive silicone. The typical pressure-sensitive adhesives have the properties of high bond strength, shear strength, solvent-free processability from the melt, high water resistance (in contrast to dispersion coatings), favorable costs or high UV stability and stability to thermal aging.

Adhesive tapes for bonding to low-energy surfaces are therefore typically manufactured with adhesives based on natural rubber, styrene block copolymer, and acrylate. The natural rubber adhesives contain solvent and have low aging and UV stability. Styrene block copolymer adhesives, generally based on styrene-isoprene-styrene block copolymers, can be processed without solvent, but likewise have low aging and UV stability. Both types of adhesive exhibit good adhesion to low-energy surfaces. Adhesives based on hydrogenated styrene block copolymers are very expensive, have low tack and bond strength, and therefore adhere poorly to many substrates. They likewise soften at well below 100° C. Acrylate adhesives have good aging and UV stability, but adhere poorly, in spite of all efforts made to date, to low-energy, apolar polymers such as polyethylene, for example, and for this reason the surfaces to be bonded must be pretreated with solvent-containing primers. Silicone pressure-sensitive adhesives have good aging stability and UV stability and good adhesion to low-energy surfaces, but are extremely expensive and cannot be lined with the usual siliconized liners (or cannot be removed from them again).

There has long been a desire for an adhesive which combines the positive properties of the various adhesives with one another: absence of solvent, high adhesion even to low-energy surfaces, and aging and UV stability like acrylate adhesives, and also favorable costs and sufficient shear strength.

It is an object of the invention to provide a pressure-sensitive adhesive, for an adhesive tape, for example, that does not have the disadvantages of the prior art.

This object is achieved by means of a pressure-sensitive adhesive as recorded in the main claim. Advantageous developments of the subject matter of the invention, and uses of the adhesive, are found in the dependent claims. The focal point of the invention is a specific propylene resin, despite the fact that those in the art considered it hitherto unimaginable that a polypropylene might have any suitability for pressure-sensitive adhesives.

The invention accordingly provides a pressure-sensitive adhesive comprising a preferably isotactic polypropylene resin having a density of between 0.86 and 0.89 g/cm³, preferably between 0.86 and 0.88 g/cm³, more preferably between 0.86 and 0.87 g/cm³, and having a crystallite melting point of at least 105° C., preferably at least 115° C., more preferably at least 135° C., very preferably at least 150° C., and comprising at least one tackifier resin, the fraction of the tackifier resin being at least 20 phr, preferably at least 50 phr. “phr” denotes parts by weight based on 100 parts by weight of rubber or polymer (parts per hundred rubber or resin), which in this case means based on 100 parts by weight of polypropylene resin. A pressure-sensitive adhesive of this kind is capable of giving an adhesive tape a bond strength to steel of at least 0.5 N/cm, preferably at least 1 N/cm.

It has been determined that when using a highly compatible tackifier resin, optionally with addition of a plasticizer, the melting peak of propylene resins having a crystallite melting point of well below 100° C. is lost in an adhesive formulation—in other words, it has been determined that, at room temperature, there is no shear strength as a result of crystalline crosslinking. With further preference, the plasticizer is also highly compatible with the polypropylene resin. In order to be able to attain any pressure-sensitive adhesiveness at all, the crystallinity must be low, and this is manifested in a low density, low flexural modulus, and low heat of fusion. Through an increasing fraction of comonomer, there is a reduction in the crystallinity, but also in the crystallite melting point T_{cr}. The latter is governed by the empirical relationship

T_{cr}=(−5.12* X_{E}+145.68)*° C.,

where X_{E} is the fraction of ethylene in mol%. The precise figures in the relationship may be influenced somewhat by the polymerization conditions, and in principle apply to other comonomers as well, such as butene. Recently, certain propylene resins have appeared with low density and crystallinity, and, in addition to the melting peak of well below 100° C., as is typical for soft propylene random copolymers, also have a small melting peak of above 100° C. This peak has a relatively low heat of fusion. In accordance with the invention, the heat of fusion of the polypropylene resin is preferably between 3 and 18 J/g. For comparison, the heat of fusion in the case of a propylene homopolymer or a heterophase copolymer is above 100 J/g (the literature values for the heat of fusion of pure propylene crystals are 165 or 189 J/g). It has been determined, surprisingly to the skilled person, that for the propylene resins of the invention, following blending with a highly compatible tackifier resin, optionally with addition of a plasticizer—in particular, a highly compatible plasticizer—the melting peak of above 100° C. is retained in principle, albeit when the crystallite melting point is then approximately 5° C. lower than in the case of the pure propylene resin.
Propylene resins of this kind now allow the production of pressure-sensitive adhesives. The pure propylene resin, on account of a sufficient heat of fusion or crystallinity in the range from 30° C. to 165° C., can be handled in the form of granules at room temperature, and this allows processing on an extruder. Through substantial disappearance of the crystallinity by blending with tackifier resin, optionally with addition of a plasticizer—more particularly, a highly compatible plasticizer—the mixture becomes pressure-sensitively adhesive. However, as a result of substantial retention of the crystallinity of the melting peak of above 100° C., the pressure-sensitive adhesive of the invention exhibits physical crosslinking, as a result of the crystalline regions, at service temperature, i.e., room temperature to at least 70° C., and this physical crosslinking gives it sufficient shear strength, in contrast to a pressure-sensitive adhesive produced from a typical random copolymer.
Propylene resins of the invention can be prepared by processes of the kind customary for heterophase polypropylene copolymers, but differ from the latter in that the fraction of comonomer is very much higher and the crystallinity is very much lower. The basis for such processes is that polymerization takes place not in one but instead in at least two reactors or in a reactor cascade, with the ratio of propylene and comonomer being different in each reactor. Suitability is possessed by numerous gas-phase processes, such as the Spheripol, Hypol, Catalloy and Novolen processes. The Spherizone process as well, which features only one reactor, but in which there are at least two zones with different reaction conditions, is suitable in principle for preparing the propylene resins of the invention.

In the text below, the term “pressure-sensitive adhesive” is sometimes abbreviated to PSA. A PSA is a viscoelastic material which at room temperature in the dry state is permanently tacky and remains adhesive. Bonding is accomplished by gentle applied pressure, instantaneously, to all substrates with sufficient surface tension (hence excluding silicone and Teflon).

PSAs for purposes of this invention are those which are capable of giving an adhesive tape a bond strength to steel of at least 0.5 N/cm, preferably at least 1 N/cm.

Propylene polymers were hitherto considered by the skilled person not to be suitable for PSAs. Surprisingly, from polypropylene resins having a density of between 0.86 and 0.89 g/cm³ and a crystallite melting point of at least 105° C., it is possible to produce PSAs with high bond strength, high tack and high shear strength, which exhibit an outstanding adhesion to a very large number of substrates, and in particular to low-energy surfaces such as apolar paints or olefin plastics.

The polypropylene resin of the invention preferably has a melt index of 0.5 to 10 g/10 min, more preferably 3 to 8 g/10 min. The flexural modulus of the polypropylene resin is preferably less than 50 MPa, more preferably less than 26 MPa.

In accordance with a further advantageous embodiment of the invention, the polypropylene resin comprises propylene and at least one further comonomer selected from the other C₂ to C₁₀ olefins, preferably C₂ to C₁₀ α-olefins. Particularly suitable are copolymers of 1-butene and ethylene, and especially copolymers of 1-butene and propylene, and also terpolymers of propylene, but-1-ene, and ethylene.

The polypropylene resin comprises preferably 75 to 95 mol %, more preferably 80 to 90 mol %, of propylene as monomer. If the fraction of propylene is higher, the PSA has too little tack for the majority of typical applications, and, if the fraction of propylene is lower, then the shear strength (cohesion) is too low. The crystalline fraction of the polymer is determined by syndiotactic, or preferably, isotactic propylene sequences. A predominantly ethylene-containing polymer in which the crystalline fraction is formed by ethylene sequences is unsuitable on account of inadequate melting point.

The polypropylene resin may have been constructed in a variety of ways—for example, as a block copolymer, as a graft polymer or as what is called a reactor blend, as in the case of heterophase polypropylenes (also called impact polypropylene or—not entirely correctly, but commonly—polypropylene block copolymer). The polypropylene resin is not a conventional, nonheterophase random polypropylene copolymer with a low melting point, comprising the propylene monomer and the other olefin monomer (ethylene or butene, for example) in random distribution, since these polymers are able to attain only low shear strengths, bond strengths, and heat resistances. A heterophase polypropylene may, however, include small amounts of a comonomer in the crystalline component, as long as the crystallite melting point is still within the range according to the invention.

The size of the polypropylene crystals of the polypropylene resin is preferably below 100 nm, giving the PSA a high transparency. A polypropylene resin of this kind can be prepared with a zirconium-based metallocene catalyst. The polypropylene resin preferably has a haze, measured in accordance with ASTM D 1003, of below 8 (measured on compression moldings 2 mm thick, in cyclohexanol).

The density of the polypropylene resin is determined in accordance with ISO 1183 and is expressed in g/cm³. The melt index is tested in accordance with ISO 1133 under 2.16 kg, and is expressed in g/10 min. The figures specified in the present disclosure are determined—as the skilled person is well aware—at different temperatures, depending on the principal monomer of the polymer; in the case of predominantly ethylene-containing or 1-butene-containing polymers, the relevant temperature is 190° C., and in the case of predominantly propylene-containing polymers is 230° C. The flexural modulus is to be determined in accordance with ASTM D 790 (secant modulus at 2% strain). The crystallite melting point (T_{cr}) and the heat of fusion are determined by DSC (Mettler DSC 822) with a heating rate of 10° C./min in accordance with ISO 3146; where two or more melting peaks occur, the peak with the highest temperature is selected, since only melting peaks above 100° C. will be retained, and effective, in PSA formulations, whereas melting peaks considerably below 100° C. are not retained and have no effect on the product properties. The heat of fusion determines first the bond strength and tack of the formulation, and secondly the shear strength, especially under hot conditions (i.e., 70° C. and above). The heat of fusion of the polypropylene resin is therefore significant for the ideal tradeoff in technical adhesive properties, and is preferably between 3 and 18 J/g, more preferably between 5 and 12 J/g.

The heat of fusion of the PSA is therefore likewise significant for the ideal tradeoff in technical adhesive properties, and is preferably between 1 and 6 J/g, more preferably between 2 and 5 J/g.

The amount of polypropylene resin of the invention in the PSA is preferably at least 15% by weight, more preferably at least 20% by weight.

The amount of polypropylene resin of the invention in the PSA is, with further preference, below 40% by weight, more preferably below 35% by weight, and very preferably below 30% by weight, allowing particularly good tack to be attained in the case of PSAs.

The polypropylene resin of the invention may be combined with the elastomers that are known from rubber compositions, such as natural rubber or synthetic rubbers. In this way there is no need for liquid, migratable plasticizers. It is preferred to use unsaturated elastomers such as natural rubber, SBR, NBR or unsaturated styrene block copolymers only in small amounts or, with particular preference, not at all. Synthetic rubbers with saturation in the main chain, such as polyisobutylene, butyl rubber, EPM, HNBR or hydrogenated styrene block copolymers, are preferred for the case of a desired modification.

It has surprisingly emerged that tack and bond strength of the polypropylene-based adhesive of the invention, in contrast to conventional rubber compositions, are very dependent on the polydispersity of the resin. The polydispersity is the ratio of weight average to number average in the molar mass distribution, and can be determined by means of gel permeation chromatography. As tackifier resin, therefore, use is made of those having a polydispersity of less than 2.1, preferably less than 1.8, more preferably less than 1.6. The highest tack is achievable with resins having a polydispersity of 1.0 to 1.4.

As tackifier resin for the PSA of the invention it has emerged that resins based on rosin (balsam resin, for example) or on rosin derivatives (for example, disproportionated, dimerized or esterified rosin), preferably in partially or completely hydrogenated form, are highly suitable. Among all tackifier resins, they have the greatest tack, probably due to the low polydispersity of 1.0 to 1.2. Terpene-phenolic resins are likewise suitable, but lead only to moderate tack, and yet result in very good shear strength and aging resistance.

Preference is likewise given to hydrocarbon resins, which are highly compatible presumably on account of their polarity. These resins are, for example, aromatic resins such as coumarone-indene resins or resins based on styrene or α-methylstyrene or on cycloaliphatic hydrocarbon resins from the polymerization of C₅ monomers such as piperylene from C₅ or C₉ fractions from crackers, or terpenes such as β-pinene or δ-limonene, or combinations thereof, preferably in partially or completely hydrogenated form, and hydrocarbon resins obtained by hydrogenating aromatics-containing hydrocarbon resins or cyclopentadiene polymers.

Additionally, resins based on polyterpenes, preferably in partially or completely hydrogenated form, may be used.

The amount of tackifier resin is preferably 130 to 350 phr, more preferably 200 to 240 phr.

The adhesive preferably comprises a liquid plasticizer such as, for example, aliphatic (paraffinic or branched), cycloaliphatic (naphthenic), and aromatic mineral oils, esters of phthalic, trimellitic, citric or adipic acid, lanolin, liquid rubbers (for example, low molecular mass nitrile rubbers, butadiene rubbers or polyisoprene rubbers), liquid polymers of isobutene and/or butene, liquid resins and plasticizer resins having a melting point below 40° C. and based on the raw materials of tackifier resins, especially the above-recited classes of tackifier resin. Particularly preferred are liquid isobutene polymers such as isobutene homopolymer or isobutene-butene copolymer, and esters of phthalic, trimellitic, citric or adipic acid, more particularly their esters with branched octanols and nonanols. Mineral oils are very suitable for imparting tack to the polypropylene resin, but may migrate into substrates to be bonded, and therefore, in accordance with one possible embodiment, the adhesive is substantially free from mineral oils.

The melting point of the tackifier resin (determination in accordance with DIN ISO 4625) is likewise significant. Typically, the bond strength of a rubber composition (based on natural or synthetic rubber) increases in line with the melting point of the tackifier resin. With the polypropylene resin of the invention, the opposite appears to be true. Tackifier resins with a high melting point (105° C. to 140° C.) are significantly less favorable than those having a melting point below 90° C., which are preferred by the invention. Resins having a melting point of below 85° C. are not widely available commercially, since the flakes or pellets cake together in transit and in storage. In accordance with the invention, therefore, it is preferred to combine a customary tackifier resin (having, for example, a melting point from the 85° C. to 105° C. range) with a plasticizer in order to achieve a de facto reduction in the resin melting point. The mixed melting point is determined on a homogenized mixture of tackifier resin and plasticizer, with the two components being present in the same proportion as in the adhesive. This melting point is preferably in the range from 45° C. to 95° C.

Conventional adhesives based on natural rubber or unsaturated styrene block copolymers as elastomer component typically comprise a phenolic antioxidant in order to prevent the oxidative degradation of said elastomer component with double bonds in the polymer chain. The adhesive of the invention, however, comprises a polypropylene resin without oxidation-sensitive double bonds, and can therefore manage without an antioxidant, this being of advantage, for example, for applications on the skin.

In order to optimize the properties, however, the self-adhesive employed may be blended with further additives such as primary and secondary antioxidants, fillers, flame retardants, pigments, UV absorbers, antiozonants, metal deactivators, light stabilizers, flame retardants, photoinitiators, crosslinking agents or crosslinking promoters. Suitable fillers and pigments are, for example, carbon black, titanium dioxide, calcium carbonate, zinc carbonate, zinc oxide, silicates or silica. Preference is given to hollow bodies of glass or polymers such as microballoons, especially hollow beads. In the case of single-layer adhesive tapes, the addition of glass fibers or polymer fibers is preferred.

It is preferred to use a primary antioxidant and with particular preference a secondary antioxidant as well. In the preferred embodiments the adhesives of the invention comprise at least 2 phr, more preferably 6 phr, of primary antioxidant or preferably at least 2 phr, more particularly at least 6 phr, of a combination of primary and secondary antioxidants, it not being necessary for the primary and secondary antioxidant functions to be present in different molecules, but instead it also being possible for these functions to be united in one molecule. The amount of secondary antioxidant is preferably up to 5 phr, more preferably 0.5 to 1 phr. It has surprisingly been found that a combination of primary antioxidants (for example sterically hindered phenol or C radical scavengers such as CAS 181314-48-7) and secondary antioxidants (for example, sulfur compounds, phosphites or sterically hindered amines) produces an enhanced compatibility. In particular, the combination of a primary antioxidant, preferably sterically hindered phenol having a relative molar mass of more than 500 daltons, with a secondary antioxidant from the class of the sulfur compounds or from the class of the phosphites, preferably having a relative molar mass of more than 500 daltons, is preferred, with the phenolic, sulfur-containing, and phosphitic functions not necessarily being present in three different molecules, but it also being possible for more than one function to be united in one molecule.

With further preference the PSA comprises a further copolymer or terpolymer of ethylene, propylene, but-1-ene, hex-1-ene or oct-1-ene, with the flexural modulus of the copolymer or terpolymer being preferably below 20 MPa and/or the crystallite melting point being preferably below 60° C. and/or the density being between 0.86 and 0.87 g/cm³. The amount of copolymer or terpolymer is preferably above 100 phr.

Additionally possible are adhesives in which no plasticizers or other additives or adjuvants are used.

The PSA can be prepared and processed from solution and also from the melt. Preferred processes for preparation and processing take place from the melt. For the latter case, suitable production processes include both batch processes and continuous processes. Particular preference is given to the continuous manufacture of the PSA by means of an extruder and its subsequent coating directly onto the substrate to be coated, with the adhesive at an appropriately high temperature. Preferred coating processes for PSAs are extrusion coating with slot dies, and calender coating.

The subject matter of the invention is used preferably in a single- or double-sidedly adhesive tape. In the case of multilayer construction of the adhesive tape, two or more layers may be applied over one another by coextrusion, laminating or coating. Coating may take place directly onto the carrier or onto a liner, or onto an in-process liner.

The (pressure-sensitive) adhesive may be present
without carrier and without further layers,
without carrier, with a further PSA layer,
single-sidedly on a carrier, with the other side of the carrier bearing another PSA, preferably based on polyacrylate, or bearing a sealing layer, or
double-sidedly on a carrier, in which case the two PSAs may have the same or different compositions.

The adhesive is preferably lined on one or both sides with a liner. The liner for the product or the in-process liner is, for example, a release paper or release film, preferably with silicone coating. Liner carriers contemplated include, for example, films of polyester or polypropylene, or calendered papers, with or without a dispersion coating or polyolefin coating.

The coatweight (thickness of coating) of a layer is preferably between 15 and 300 g/m², preferably between 20 and 75 g/m².

The adhesive tape has a bond strength to steel of at least 0.5 N/cm, preferably at least 1 N/cm, more preferably at least 2 N/cm, very preferably at least 6 and more particularly at least 9 N/cm. The bond strength to steel is determined at a peel angle of 180° in accordance with AFERA 4001 on a test strip 15 mm wide. Accordingly, low-tack films such as surface protection, stretch films or clingfilm are not adhesive tapes for the purposes of this invention. The adhesive or adhesive tape is notable for a high tack. The ball tack according to PSTC 6 is generally below 10 cm and usually below 5 cm. In the PSTC 6 measurement, a steel ball with a diameter of 1.1 cm rolls from an inclined plane with a semicircular inside surface (65 mm ramp) under an angle of inclination of 21° 30′ onto the layer of adhesive on the test strip. The distance traveled by the ball to standstill is taken as a measure of the tack. The greater the distance traveled by the ball, the lower the ball tack.

Preferably at least one layer, preferably the layer of the invention, is crosslinked. This can be done by means of high-energy radiation, preferably electron beams, or by peroxide or silane crosslinking.

As carrier material it is possible to use all known carriers, such as, for example, scrims, woven fabrics, knitted fabrics, nonwovens, films, papers, tissues, foams, and foamed films. Suitable films are those of polypropylene, preferably oriented, polyester, and unplasticized and/or plasticized PVC. Preference is given to polyolefin foam, polyurethane foam, EPDM, and chloroprene foam. By polyolefin here is meant polyethylene and polypropylene, with polyethylene being preferred on account of the softness. The term “polyethylene” includes LDPE, but also ethylene copolymers such as LLDPE and EVA. Particularly suitable are crosslinked polyethylene foams or viscoelastic carriers. The latter are made preferably of polyacrylate, more preferably filled with hollow bodies of glass or polymers. Before being combined with the adhesive, the carriers may be prepared by priming or by physical pretreatment such as corona. Crosslinked polyethylene films are treated in this way for double-sidedly adhesive tapes, since the adhesion of acrylate PSAs to the crosslinked polyethylene foams is very poor and is not very satisfactory even with treatment, the reason being that these carriers, as a result of the production process, contain lubricants such as erucamide. It is therefore entirely surprising that the compositions of the invention, even without treatment, adhere outstandingly to such foams—in other words, when a forceful attempt is made to detach them, it is the foam which is destroyed.

The expression “adhesive tape” for the purposes of this invention encompasses all sheetlike structures such as two-dimensionally extended films or film sections, tapes with extended length and limited width, tape sections, diecuts, labels, and the like. The adhesive tape takes the form preferably of a continuous web, in the form of a roll, and not a diecut or label. In contrast to surface protection films with only a weak tack, an “adhesive tape” in the sense of the invention comprehends an article having a distinct adhesion, which can be expressed, for example, by bond strength to steel of at least 0.5 N/cm, preferably at least 1.0 N/cm.

The adhesive tape may be produced in the form of a roll, in other words in the form of an Archimedean spiral wound up onto itself.

The adhesive (PSA) of the invention in an adhesive tape is suitable for bonding to substrates comprising apolar paints, printing plates or olefinic plastics with outstanding effect, and, with particular preference, for the closing or strapping of polyolefin pouches or for the fixing of parts made from olefinic plastics or elastomers, especially for the fixing of parts in motor vehicles.

With double-sided adhesive tapes featuring an unsiliconized liner film of polyolefin, the problem exists that the liner film, following application of the adhesive tape to—for example—a plastics profile, is difficult to remove, and hence it is necessary to weld a loop of polyolefin onto one end. In an adhesive tape, the adhesion of the adhesive of the invention to the plastics profile is sufficiently strong that the liner film is easy to remove.

Furthermore, the subject matter of the invention is ideal for labels on cosmetics packaging (for example, shampoo bottles), since it is highly transparent, adheres well to plastic bottles, is water-resistant, and is stable to aging. In the case of security labels such as magnetic alarm labels or data carriers such as Holospot®, the subject matter of the invention solves the problem of the poor adhesion of conventional adhesives to apolar substrates. The adhesive of the invention in an adhesive tape is suitable, furthermore, for bonding to human skin and to rough substrates in the construction segment, as an adhesive packaging tape, and for wrapping applications. Examples of applications on human skin are plasters in individual form and in roll form, diecuts for the bonding of colostomy bags and electrodes, active ingredient patches (transdermal patches), and bandages. On account of the adhesive properties, the adhesive affords the possibility of avoiding substances with a skin irritant effect or other chemical effect. Accordingly, the adhesives of the invention are also suitable for the construction of sanitary products such as diapers or sanitary towels, and, furthermore, adhere especially well to the polyolefin films and nonwoven webs that are used in such products, and have lower costs and higher heat resistance than conventional compositions comprising hydrogenated styrene block copolymers. Moreover, PSAs of the invention can be used for sanitary products such as diaper closures or sanitary towels. Examples of wrapping applications are electrical insulation and the production of automobile cable looms. In contrast to natural or synthetic rubber adhesives, the adhesives of the invention are compatible even at high temperatures with PP, PE and PVC wire insulation. In construction applications, as a plaster tape, for the bonding of roof insulation films, and as an adhesive bitumen tape for sealing applications, good low-temperature bonding performance is observed. The subject matter of the invention is suitable, furthermore, for film applications, in other words, for example, for the laminating of films such as polyolefin film or polyamide film to aluminum foil, and is easier to handle than solvent adhesives or UV laminating adhesives. Further film applications are adhesive starter tapes for the continuous bonding of printed or unprinted film webs. Other applications are in strippable adhesive strips (pressure-sensitive adhesive film strips comprising at least one layer which can be redetached without residue or destruction by extensive stretching substantially in the plane of the bond), and on touch-and-close fasteners, like those offered on the large scale by the company Velcro®.

The invention is illustrated below by a number of examples, without thereby wishing to restrict the invention.

Raw materials in the examples:

| | |
|---|---|
| NOTIO PN-3560: | Copolymer of propylene and but-1-ene (optionally with small amounts |
| | of ethylene as well), melt index 6 g/10 min, density 0.866 g/cm³, |
| | flexural modulus 12 MPa, crystallite melting point 161° C., heat of |
| | fusion 16.9 J/g |
| NOTIO PN-0040: | Copolymer of propylene and but-1-ene (optionally with small amounts |
| | of ethylene as well), melt index 4 g/10 min, density 0.868 g/cm³, |
| | flexural modulus 42 MPa, crystallite melting point 159° C., heat of |
| | fusion 5.2 J/g |
| Softell CA02: | Copolymer of propylene and ethylene, melt index 0.6 g/10 min, density |
| | 0.870 g/cm³, flexural modulus 20 MPa, crystallite melting point |
| | 142° C., heat of fusion 9.9 J/g |
| PP4352F3: | Homopolymer of propylene, melt index 3 g/10 min, density 0.9 g/cm³, |
| | flexural modulus 1400 MPa, crystallite melting point 160° C. |
| Versify 2400: | Copolymer of propylene and ethylene, melt index 2 g/10 min (230° C.), |
| | density 0.86 g/cm³, flexural modulus 2 MPa, crystallite melting point |
| | 48° C. |
| Exact 4053: | Random copolymer of ethylene and but-1-ene, melt index 2.2 g/10 min |
| | (190° C.), density 0.888 g/cm³, flexural modulus 27 MPa, crystallite |
| | melting point 70° C. |
| Ondina 933: | White oil (paraffinic-naphthenic mineral oil) |
| Shell Bitumen R 85/25: | Oxidation bitumen with a softening point of 85° C. |
| Indopol H-100: | Polyisobutene-polybutene copolymer having a kinematic viscosity of |
| | 210 cSt at 100° C. to ASTM D 445 |
| Wingtack 10: | Liquid C₅ hydrocarbon resin |
| Escorez 1310: | Nonhydrogenated C₅ hydrocarbon resin having a melting point of |
| | 94° C. and a polydispersity of 1.5 |
| Regalite R1100: | Hydrogenated aromatic hydrocarbon resin having a melting point of |
| | 100° C. and a polydispersity of 1.6 |
| Foral 85: | Fully hydrogenated glycerol ester of rosin, having a melting point of |
| | 85° C. and a polydispersity of 1.2 |
| Irganox 1726: | Phenolic antioxidant with sulfur-based function of a secondary |
| | antioxidant |
| Irganox 1076: | Phenolic antioxidant |
| Tinuvin 622: | HALS light stabilizer |

### EXAMPLE 1

The adhesive is composed of the following components:

### 100 phr NOTIO PN-0040, 78.4 phr Wingtack 10, 212 phr Escorez 1310 and 8 phr Irganox 1726.

The adhesive is prepared continuously in an extruder and applied from the melt by means of nozzle coating to a 25 g/m² tissue at 70 g/m² on both sides. The product is lined with a siliconized, polyethylene-coated release paper.

The bond strengths are determined at a peel angle of 180° in accordance with AFERA 4001 on a test strip 15 mm wide. The side not bonded to steel or polypropylene is lined, prior to measurement of the bond strength, with an etched polyester film 25 μm thick. The bond strength to steel of the open side and of the lined side is in each case 8.4 N/cm. The bond strength to a polypropylene plate is in each case >10 N/cm (polyester film detaches from the adhesive tape). The ball tack is 1.5 cm. The heat of fusion of the PSA is 1.6 J/g.

### EXAMPLE 2

In an extruder, a mixture of 50% by weight Shell Bitumen R 85/25, 15% by weight Ondina 933, 15% by weight Indopol H-100 and 20% NOTIO PN-0040 is prepared, and is extruded in a thickness of 500 μm onto a single-sidedly siliconized release film of polyethylene with a polyamide barrier layer, which at the end of the line is laminated to an aluminum foil 50 μm thick, and then converted into rolls with a width of 50 mm.

The bond strength is 13 N/cm. The shear strength is 55 min. The ball tack is 3 cm.

### EXAMPLE 3

The adhesive is prepared as in example 1 and applied at 50 g/m² to a viscoelastic polyacrylate carrier 800 μm thick. This carrier is produced in accordance with the example “Carrier VT1” from WO 2006/027389 A1. The other side is laminated likewise at 50 g/m² but to an acrylate solvent composition PA 1 corresponding to the stated application.

Bond strength to steel of the polypropylene resin composition is 12 N/cm, and that of the acrylate composition 15 N/cm. The ball tack is 2 cm. Bond strength of the polypropylene resin composition to a polypropylene plate is more than 10 N/cm, and that of the acrylate composition 2 N/cm.

### EXAMPLE 4

The adhesive is prepared as in example 1 and applied from the melt, by nozzle coating, at 70 g/m² to a woven polyester fabric. The filament fabric has a basis weight of 130 g/m², comprising 167 dtex polyester yarn with 45 threads per cm in warp direction and 25 threads per cm in weft direction.

Bond strength to steel 8.6 N/cm, bond strength to reverse 4.8 N/cm. The ball tack is 2 cm. Roll storage 1 month at 70° C.: the roll is slightly deformed and readily unwindable. Compatibility testing: the completed adhesive tape is wrapped around a pair of wires with different insulating materials, in accordance with LV 312-1 “Protective systems for lead harnesses in motor vehicles, adhesive tapes; testing guideline” (02/2008), a joint standard of the companies Daimler, Audi, BMW, and Volkswagen, and is stored at the appropriate temperature.

Six such test specimens are produced for each insulating material. Every 500 hours, one of the specimens is inspected, the adhesive tape is unwound again, and the cable is wound around a 10 mm diameter mandrel and around a 2 mm diameter mandrel. Inspection is carried out to determine whether the insulation is damaged and whether the adhesive exhibits tack (test temperatures: on PVC at 105° C. and on crosslinked PE at 125° C.). After 3000 hours, all of the wire insulations are still undamaged. After 3000 hours at 105° C., there has been no penetration of the composition into the carrier, and the composition still has good tack. After 3000 hours at 125° C., the composition has undergone partial penetration into the carrier, but is still tacky.

### EXAMPLE 5

The carrier film is Radil TM 35 μm (biaxially oriented polypropylene homopolymer film). It is coated on the corona-treated side with polyvinyl stearyl carbamate from toluene solution, and on the facing side is equipped with 28 g/cm² of a hotmelt PSA having the following composition: 100 phr Softell CA02, 78.4 phr Ondina 933, 212 phr Escorez 1310 and 3 phr Irganox 1076.

The bond strength to steel is 2.5 N/cm. The ball tack is 6 cm. The tack is determined by applying a sample to kraft paper, in the same way as described for the determination of bond strength, and rapidly removing the sample. The tack is good, since over more than 50% of the bond area, the paper fibers are extracted and in part the paper splits.

### EXAMPLE 6

A hotmelt PSA with the following composition is prepared in a compounder and coated onto a film as in example 5: 100 phr NOTIO PN-0040, 78.4 phr Wingtack 10, 212 phr Foral 85 1310, 8 phr Irganox 1726.

The bond strength to steel for a coatweight of 20 g/m² is 14 N/cm. The tack is good, because the paper slits. The ball tack is 7 cm.

The bond strength to steel at a coatweight of 70 g/m² is 17 N/cm and the ball tack is 4 cm.

### EXAMPLE 7

A hotmelt PSA with the following composition is prepared in a compounder and coated with a coatweight between two liners: 100 phr NOTIO PN-0040, 78.4 phr Versify 2400, 150 phr Foral 85 1310, 8 phr Irganox 1726.

For determining the strippability, 20 test specimens 20 mm wide and 50 mm long are produced. As grip tabs, both sides are lined at one end with a 25 pm polyester film measuring 20 mm times 20 mm. The opposite end is cut conically, with the tip having a width of 2 mm and the length of the cone being 20 mm, meaning that, between the grip tab and the beginning of the cone, the sample remains 20 mm wide over a length of 10 mm. The sample is bonded between two glass plates in such a way that the adhesive is fully covered and only the grip tab protrudes. After the 10 days of storage, the 20 test specimens are parted by pulling, with pulling taking place at an angle of 15°. A record is made of the number of adhesive strips torn away: Zero.

### COMPARATIVE EXAMPLE 1

The embodiment is as described in example 1, but with PP4352F3 instead of NOTIO PN-0040. The coating is not tacky, but instead hard with an oily surface. The ball tack is more than 30 cm.

### COMPARATIVE EXAMPLE 2

The embodiment is as described in example 1, but with Versify 2400 instead of NOTIO PN-0040. The coating is very soft and tacky. The bond strength cannot be measured, owing to cohesive fracture. The ball tack is 1 cm.

### COMPARATIVE EXAMPLE 3

The embodiment is as described in example 1, but with the following formula:

### 100 phr Versify 2400, 12.5 phr PP4352F3, 212 phr Escorez 1310.

The coating is not tacky, but instead hard. The ball tack is more than 30 cm.

### COMPARATIVE EXAMPLE 4

The embodiment is as described in example 5, but with the following formula:

### 100 phr NOTIO PN-0040, 78.4 phr Ondina 933 and 3 phr Irganox 1076.

The sample adheres easily to glass; the bond strength to glass and to steel is below 0.1 N/cm. The ball tack is more than 30 cm.

### COMPARATIVE EXAMPLE 5

The embodiment is as described in example 5, but with the following formula:

### 100 phr NOTIO PN-0040, and 3 phr Irganox 1076.

The sample adheres easily to glass; the bond strength to glass and to steel is below 0.1 N/cm. The ball tack is more than 30 cm.

### COMPARATIVE EXAMPLE 6

The embodiment is as described in example 5, but with the following formula:

100 phr (45% by weight) NOTIO PN-0040, 111 phr (50% by weight) Exact 4053, and 11 phr (5% by weight) Regalite R1100.
The bond strengths are 0.02 N/cm to steel and 0.05 N/cm each to polycarbonate and Plexiglas (acrylate, PMMA). The sample does not adhere to Kraft paper. The ball tack is more than 30 cm.

1. A pressure-sensitive adhesive comprising a polypropylene resin having a density of between 0.86 and 0.89 g/cm³, a crystallite melting point of at least 105° C., and comprising at least one tackifier resin, the fraction of the tackifier resin being at least 20 phr.

2. The pressure-sensitive adhesive of claim 1, wherein the polypropylene resin has
a melt index of 0.5 to 10 g/10 min and/or
a flexural modulus of less than 50 MPa, preferably less than 26 MPa.

3. The pressure-sensitive adhesive of claim 1,
the polypropylene resin is in the form of a block copolymer, graft polymer or heterophase polypropylene and/or
has isotactic propylene sequences.

4. The pressure-sensitive adhesive of claim 1, wherein
the heat of fusion of the polypropylene resin is between 3 and 18 J/g.

5. The pressure-sensitive adhesive of claim 1, wherein
the polypropylene resin comprises propylene and at least one further comonomer other than propylene selected from the group consisting of C₂ to C₁₀ olefins.

6. The pressure-sensitive adhesive of claim 1, wherein
the polypropylene resin comprises 75 to 95 mol % of propylene.

7. The pressure-sensitive adhesive of claim 1, wherein the amount of polypropylene resin in the pressure-sensitive adhesive is at least 15% by weight.

8. The pressure-sensitive adhesive of claim 1, wherein
the amount of polypropylene resin in the pressure-sensitive adhesive is below 40% by weight.

9. The pressure-sensitive adhesive of claim 1, wherein
the heat of fusion of the pressure-sensitive adhesive is between 1 and 6 J/g.

10. The pressure-sensitive adhesive of claim 1, wherein
the tackifier resin has a polydispersity of less than 2.1.

11. The pressure-sensitive adhesive of at claim 1, wherein
the tackifier resin is selected from the group consisting of
resins based on rosin or rosin derivatives,
hydrocarbon resins based on C₅ monomers,
hydrocarbon resins from hydrogenation of aromatics-containing hydrocarbon resins,
hydrocarbon resins based on hydrogenated cyclopentadiene polymers, and
resins based on polyterpenes,
the amount of tackifier resin in the adhesive being 130 to 350 phr.

12. The pressure-sensitive adhesive of claim 1, wherein
the pressure-sensitive adhesive comprises a plasticizer selected from the group consisting of mineral oils, liquid polymers and esters of phthalic, trimellitic, citric or adipic acid.

13. The pressure-sensitive adhesive of claim 1, wherein
the pressure sensitive adhesive comprises
a primary antioxidant, preferably in an amount of at least 2 phr, and/or
a secondary antioxidant in an amount of 0 to 5 phr,

14. The pressure-sensitive adhesive of claim 1, wherein
the pressure-sensitive adhesive comprises a further copolymer or terpolymer of ethylene, propylene, but-1-ene, hex-1-ene or oct-1-ene, the flexural modulus of the copolymer or terpolymer being below 20 MPa and/or the crystallite melting point being below 60° C. and/or the density being between 0.86 and 0.87 g/cm³, and the amount of copolymer or terpolymer being above 100 phr.

15. A single- or double-sided adhesive tape, having at least one side coated with a layer of the pressure-sensitive adhesive of claim 1 and having a bond strength to steel of at least 1 N/cm.

16. The adhesive tape of claim 15, the coatweight of the pressure-sensitive adhesive in a the layer being between 15 and 300 g/m².

17. The adhesive tape of claim 15, having a carrier of a woven fabric, a nonwoven fabric, a tissue, a film or a foam, or a viscoelastic carrier.

18. canceled

19. The pressure-sensitive adhesive of claim 13, wherein the primary antioxidant has a sterically hindered phenolic group and/or a relative molar mass of more than 500 daltons
